(19) United States
(12) Patent Application Publication
(10) Pub. No.: US 2020/0027171 A1
(43) Pub. Date: Jan. 23, 2020

(54) Social Awareness Service

(71) Applicants: Michael A. Oren, Chicago, IL (US); Prasad Siddalinga, Wayne, PA (US)

(72) Inventors: Michael A. Oren, Chicago, IL (US); Prasad Siddalinga, Wayne, PA (US)

(21) Appl. No.: 16/518,405

(22) Filed: Jul. 22, 2019

Related U.S. Application Data
(60) Provisional application No. 62/764,245, filed on Jul. 23, 2018.

(51) Int. Cl. G06Q 50/00; G06N 20/00; G06F 16/9535

(52) U.S. Cl. CPC G06Q 50/01; G06F 16/9535; G06N 20/00

(57) ABSTRACT

Systems and methods are provided for generating recommendations for users of a service. A data processor collects raw user data and provides that data to a learning engine. The learning engine analyzes the data to generate weighted social aspect scores and further to generate a social affinity score using the weighted social aspect scores. The social affinity score is combined with information about people near the user to generate a social context, and the availability of the user is evaluated to determine whether a recommendation should be provided to the user.

### REFERENCE TO PRIOR APPLICATION

This application claims the benefit of U.S. Provisional Application Ser. No. 62/764,245, entitled “Social Awareness Service,” and filed on Jul. 23, 2018, which is incorporated herein by reference in its entirety.

### BACKGROUND

### Field of the Invention

The present invention is directed to the field of network communications and more specifically is directed to a social awareness service that provides context around user interactions as well as the level of social affinity among group members.

### Description of the Related Art

Social networks such as Facebook and Twitter have achieved a level of success and adoption based on their ability to enable communications among large groups of people. However, the means by which users discover other users using these networks are somewhat limited. There is a need for services that use a variety of different indicators of affinity to facilitate interaction among users.

### BRIEF DESCRIPTION OF THE DRAWINGS

FIG. 1 is a block diagram showing the computational inputs and data flow in a social awareness service according to one embodiment of the present invention;

FIG. 2 is a diagram illustrating one example of how users of a social awareness systems according to the present invention can be informed of an opportunity to gather;

FIG. 3 is block diagram showing the formation of records in one embodiment of the invention;

FIG. 4 is a diagram illustrating examples of data storage in one embodiment of the present invention;

FIG. 5 is a diagram illustrating an example of recommendation presentation in one embodiment of the invention;

FIG. 6 is a diagram illustrating decision making and option presentation in one embodiment of the present invention; and

FIG. 7 is a chart showing how sensors are used to collect data and output information in embodiments of the present invention.

### DETAILED DESCRIPTION

Shown and described herein are aspects of social awareness system. In one embodiment, the invention comprises a social awareness service that provides context around user interactions as well as the level of social affinity among group members. This information can then be used in conjunction with data specific to particular apps, services, or hardware to deliver an experience tailored to a social situation or social group.

In some embodiments, this invention provides insight into preferences, actions, and movements between and among groups that include approximate matches of similarity as well as proximity to other individuals that may not be connected directly in a social network with matching and recommendations provided based on a social affinity score. In some embodiments, the present invention utilizes a focus on collective action (intent, action, or preference taken or held by more than one person) rather than, or in addition to, individual action.

Services according to the present invention may be run either via a central repository on a server where information is matched by the user logging into an account that uniquely identifies the user or through local storage of the user's information on each user's own device. The server-less approach provides additional privacy and control for the end user. The peer-to-peer approach of local information storage and retrieval may still report information in aggregate form (primarily scores such as a social affinity score) to a central server on request for experiences that are not co-located (such as in experiences geared toward remote worker collaboration), although this may also be applied in co-located settings. In one embodiment, computation of those scores would take place on the user's device(s) and only the aggregate value would be reported to the central server combined with the necessary experience context.

Users may not always directly interact with the platform, which will monitor the actions they take within digital experiences that are using the service. The platform may adjust based on how users respond to recommendations the platform provides within specific services as well as changes in user behaviors and any direct input the user may provide.

This invention uses the concepts of social context and social affinity to provide recommendations.

Social affinity and social context are multidimensional constructs that take into account several factors such as proximity, sentiment, availability, user action, and awareness. In addition, either in conjunction with or as an alternative to focusing on existing connections within a social network as equally important, the present invention may use the broader understanding of social affinity among individuals and groups to bias recommendations and connections. When appropriate, it also takes into account availability when determining appropriate actions or inclusion in group decisions.

Proximity is used primarily as an input into potential social affinity when providing matching, recommendations, and an exchange with businesses. In some embodiments, this invention does not just use location history to predict where the user will be but places a greater emphasis on how users' historical movement patterns are affected by each other as their social affinity with one another grows or decreases as evidence of collective action.

The present invention is described in a variety of embodiments to illustrate operation of aspects of the invention. Each embodiment is an example of operation and, unless otherwise stated, no embodiments are meant to limit the scope of the invention.

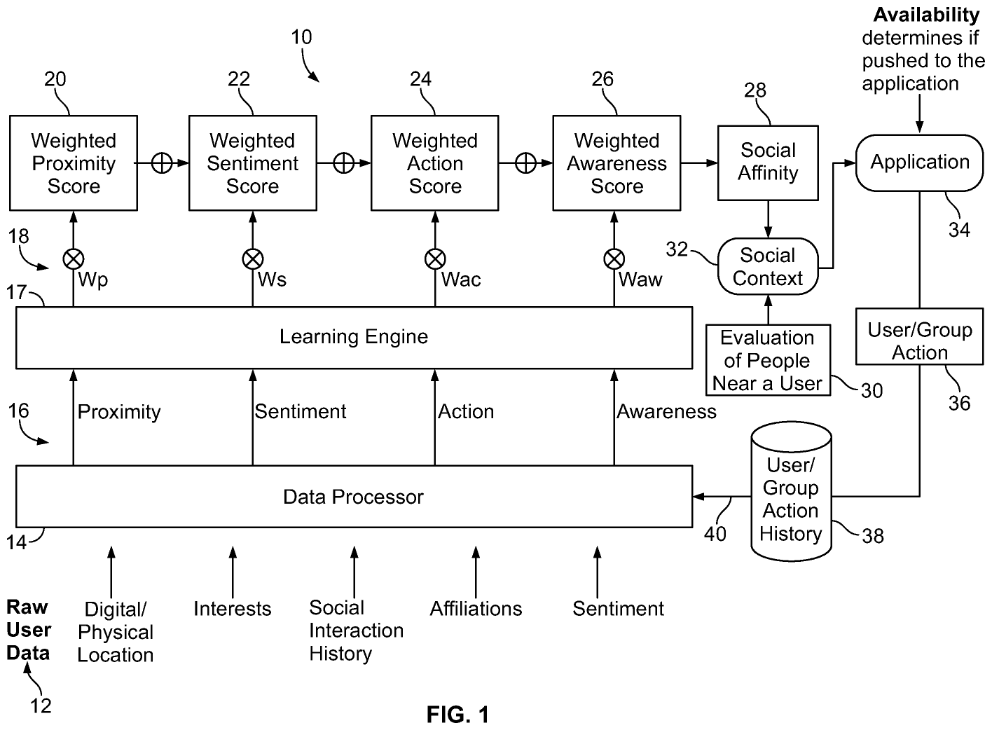

FIG. 1 illustrates the use of data in an architectural view of a social awareness service 10, in which different types of raw data 12 are processed by a data processor 14, and sorted into user data categories for proximity, sentiment, action, and awareness data as shown at 16. A learning engine 17, which may be executed on the data processor 14 or may be separate, sorts this information and as shown at 18 multiplies the sorted information by the dynamic weight for each type of information. Likewise, it is to be understood that all calculations referred to in FIG. 1 may be carried out by the data processor 14 or by a number of data processors. Weighted social aspect scores comprising a weighted proximity score 20, the weighted sentiment score 22, the weighted action score 24, and the weighted awareness score 26 are then combined into a social affinity value 28. The social affinity 28 is combined with an evaluation of people near a user 30 to determine the social context 32, and this social context is in turn used to generate a recommendation, such a suggested action, to one or more users. The availability of users is used to determine whether the resulting recommendation is pushed to an application 34.

User or group action is then evaluated as shown at 36, and can be aggregated into user/group action history as shown at 38. As shown at arrow 40, the user/group action history may be fed into the data processor 14, creating a feedback loop that allows the social awareness system to better provide recommendations.

These specific terms may be defined as follows.

Social context is a combination of social affinity and the people near a user.

Social affinity is the weighted combination of Proximity, Sentiment, Action and Awareness.

Social Affinity=Proximity*Wp+Sentiment*Ws+Action*Wac+Awareness*Waw

Wp, Ws, Wac and Waw are the dynamic weights for proximity, sentiment, action and awareness, respectively. The weights are dynamic and can be additive or subtractive depending on the context and are adjusted based on the feedback from a learning engine over time. This learning engine may evaluate an individual's responses to suggested interactions in the context of other individuals (both in the context of different group configurations and 1:1 interactions) and adjust future recommendations. In some applications some of these factors may not be relevant and can be excluded from the calculation of affinity by using a weight of 0.

Depending upon the experience context in which the social affinity score is being called, the weights may change. For example, proximity may have a weight of 50% or higher for experiences focused on promoting new conversations or finding available people for food ordering. However, in an enterprise setting where remote collaboration is being encouraged within a workplace, proximity may have a weight of 10% or less while awareness might be weighted 50% or higher.

In addition, the weighting of elements may vary based on the individuals and the current quantity of data available. For example, in a social matching context, a user who has recently registered for the social awareness service would be matched exclusively on proximity as there would be no data available for sentiment, action, or awareness. In another example, behaviors of users as determined by their willingness or unwillingness to have conversations with different individuals may end up placing a higher weight on sentiment as the algorithm determines they are unwilling to have conversations with people who do not share certain interests.

At the highest level, social affinity is empathy or feeling of connection with another person or group. Affinity is a dynamic element that may change in strength based on the four factors: proximity, sentiment, action, and awareness. Thus, people are typically more willing to build affinity for people who they are already in proximity with even when they disagree on items related to sentiment. In a similar way, people who begin to take actions that are different than their routine are often likely to adjust their sentiment around a topic. Sentiment might need to be reweighted over time, but the beginning hypothesis is that sentiment toward a topic can be heavily influenced by proximity, awareness, and actions. However, awareness is unlikely to influence affinity on its own and thus will usually not be the only factor in determining social affinity.

Social affinity can be scored as a 1:1 match between individuals, as a 1:group match where the individual is scored vs. the group aggregate; as a group aggregate:group aggregate; or situational many:many matches on a given choice (looking at sentiment, actions, proximity, and awareness vs. institutions, brands, etc.).

A group might be a social group of 2 or more people loosely or tightly (e.g. family) bonded, a formal organization (non-profit, club, corporate team, etc.); or a brand, restaurant, or store for the purposes of the algorithm of the present invention. Social affinity on a 1:1 basis occurs when there are two users are being explored as a possible match within a relevant experience context. Experience context is defined as an app, site, or other digitally augmented experience that provides a product or service to a user. Each of these apps, sites, or services may register for one or multiple contexts of use, such as social (connecting people, increasing conversations, etc.); commerce; food; navigation; etc. Navigation in this case might help a user to estimate what time he or she needs to leave in order to arrive at a pre-determined place with someone who they have an established connection with based on their typical commute to that location. It may also include recommended paths that account for the preferences in routes of everyone in the group.

Social affinity on a 1:many basis may be used for businesses or brands that want to understand the affinity score between their brands or products and potential consumers. It may also be used for social connecting by individuals to groups, for example in a case where a person moves to a new city and wishes to connect with new people.

The primary application context for 1:many social affinity is when a prioritized rank of potential people is needed based on the affinity score.

Social affinity on a many:many basis is, in one embodiment, the primary technique used within group decision making experience contexts. Many:many social affinity looks at the social affinity of each individual to the group as well as each individual to one another. The social affinity with the group is the primary metric for determining a group decision (e.g. if the group has the highest affinity score with pizza when ordering food, then pizza is recommended).

The four primary factors used in the invention will now be described in greater detail. For each factor, the ranges listed are exemplary; it is to be understood that these ranges may be optimized for certain kinds of performance.

Proximity Score=Physical location (ranging from 0-100%)+Physical Sameness [gender, ethnicity, class, etc.] (ranging from 0-10%)+Digital location [sites visited, apps installed, etc.] (ranging from 0-50%)+Temporal factors [amount of time spent, when the locations overlapped, frequency of location overlap, etc.] (ranging from 0-30%)

Physical location is defined as where the individual is located as inferred from the location coordinates obtained from the device being used. This is the location at the moment it is retrieved from the device.

Physical sameness refers to information input from the user or retrieved from images uploaded by the user that they identify as being themselves. These attributes might include but are not limited to gender, race, age, socioeconomic status, etc.

Digital location is defined as the digital touchpoint a user is currently or last interacted with at the time the service is contacted. This might be a web site, app on a phone, voice service, or some other digitally rendered context.

Temporal Factors are directly tied to physical and digital locations. This is collected by taking the time the location is entered and when it is left (duration) and counting the number of times a user enters & leaves a specific location (frequency). This applies to both physical and digital locations.

Distance may be measured by taking the coordinate points from one user and subtracting the coordinate points of the other user (as obtained by GPS). In some situations, distance may be measured by taking the relative bluetooth and Wifi signal strength between devices.

Timestamped digital and physical locations (“breadcrumbs” or history) are collected on physical and digital locations. Strength of proximity is based on temporal overlap with a minor adjustment from physical sameness.

Awareness Score=Interactions with the person (ranging from 10-100%)+Knowledge of shared interests (ranging from 0-50%)+Knowledge about infrequently shared information (ranging from 0-50%).

Interactions are defined as instances when one or more users participate in a shared experience (e.g. making a shared decision; choosing to begin a conversation with one another, etc.). If the individuals have a known history 0of interactions, then temporal overlap of physical and digital experiences may also be used to infer interactions during those times.

The following data can be used in constructing the awareness factor in the event the user has given the system permission to monitor and track text entries, whether locally only (wherein the information is wholly owned and controlled by the user and only reported in aggregate) or shared centrally to a server.

Knowledge of shared interests may be measured by interactions or sharing of information about interests in proximity to the other user, implying that the user is aware that the other person shares the interest. If the user has allowed access to message history then this might also include references to said activities or interests.

Knowledge about infrequently shared information is defined as a rarely referenced piece of information or activity that the individual user has a history of having searched for or accessed primarily in private. Additionally, this might be a piece of information the user has marked as private but has allowed another user to access.

A user may have a location they visit often by themselves or only with family members, however, if they visit that location with someone who has not been identified as a family member, then that would indicate private information being shared. The fewer people this location is shared with, the higher the score is, from 0 (common information/location) to 100 (only this person has ever gone to this place).

Users can also mark information as private in contexts where conversations might be suggested; however, if the user chooses to select to share a topic with one or a select set of individuals then that may be scored in a range from 0-100 (not at all private to very private). This score is also weighted based on the frequency and recency of the information being shared (for example, in one embodiment information only shared once or within less than a year time frame may have a maximum score from 30-75 depending on context).

While awareness is an important component of social affinity, it is used as a subtractive element for the inventive algorithm when matching or encouraging interactions. When using social data to help make a group decision, awareness becomes additive as it then assumes the person in the group who has the strongest awareness match with all other members is a key decision maker or leader within the group.

The awareness calculation most heavily weighs how often people interact, whether digitally or physically, as part of an assumption that during those interactions information and feelings become shared. For interactions where topics discussed are known (this is assumed to be minority of interactions), the shared interests may have a small weight while privileged information (topics that are deemed private/personal) may have a higher rating for purposes of awareness calculation. Information that is known may come from searches performed whether by typing or voice, digital and physical locations visited and then a device being passed to another user or being read aloud by the device, digital messages sent, or conversations that are knowingly recorded with permission.

Sentiment Score=Shared hobby interests (range 20-100%)+Shared affiliation with a group (range 0-80%)+Strengths of involvement/feelings (range 0-40%)+Frequency (range 20-100%)+depth (20-60%)+self-rating (0-20%)

The “shared hobby interests” factor is inferred if both users have a history of searching for specific topics or a hobby, are using the same types of apps or services related to a hobby, or have directly input a specific hobby into the platform of the present invention or a service that interacts with the platform.

Shared affiliation with a group may be defined formally as membership within an organization as taken from information entered within the platform or another service that interacts with the platform. It may also be inferred from searches and other activities related to the group such as going to a location associated with said group (e.g. a sports team's stadium) on a semi-regular or regular basis. For informal groups, such as a group of friends, this would be the aggregate affinity score of the individual to the people who are known to associate with one another and are currently in proximity.

Intensity or strength of involvement is an inferred score calculated by frequency (how many times) a hobby or group is looked up or interacted with; depth (for defined topics—such as a sport—is the user looking into less frequently looked up details such as historic statistics); and self-rating (the user has indicated by entering it in as an interest or hobby and may have even provided a numeric score with their level of interest).

Individuals may have shared interests (baseball, politics, music, etc.) as well as shared affiliations with a group (Democrat, Chicago Cubs, Catholic, etc.) and while those sentiments can help match individuals to one another, the intensity or strength of those attachments are better indications of the sentiment. The strength is measured by frequency of engagements, depth of engagement (time spent; less popular sites that have more content; e.g. a sports fan who dives into the stats vs. someone who only watches games), and self-rating.

Action Score=Ratings of interactions (range 0-10%)+Changes in behavior/routines (range 10-80%)+Decision made on recommendations (range 20-100%)

Ratings of interactions is defined as a user rating an experience with an individual, group, or business after having made a decision or having a conversation that was augmented or initialized by the platform. This rating may take place in the platform itself through the user inputting a number or other scaled measure or through the digital service that the user was interacting with. In some embodiments of this invention, the rating might be inferred based on the user choosing to have future interactions with the individual, group, or business or not, as well as the frequency of said interactions.

The “Changes in behavior/routines” factor is defined as deviance from the historical patterns of the user to align closer with the historic patterns of another user, group, or business. These could be changes to paths traveled, sites visited, apps interacted with, topics searched for, or any other trackable behavior or routine.

The “Decision made on recommendations” factor is defined as whether a user chooses to take an action based on a recommendation provided by the platform or not. In instances where the platform provides multiple options, this also looks at which option the user chooses to take an action on and the defining characteristics of that recommendation compared to the other ones provided. In manifestations where the recommendations are provided to multiple users within the same social group concurrently, the individual choice and agreement with the others in the group may also be considered as part of the affinity score.

While it won't be available in all experiences empowered by the social context engine (SCE), ratings of interactions where an individual rates the level of positive reaction to something (did it enrich their lives in some way?) may be given the lowest weight. Actual activity of the individual, especially in terms of changes in behavior/routine (including changes in overlap in terms of proximity & sentiment with the group or individuals) receive the greatest weight. Finally, the system includes some behaviors as measured by the user decision made on recommendations (if users are favoring preferences of one person over another, choosing to start conversations with people who have different attributes over another, etc.)

Changes in behavior are measured based on comparing average breadcrumb (physical & digital) path to new path vs. the other person or group's aggregate. Systems according to some embodiments of the present invention take into account that as people gain more affinity for one another, they will be more likely to converge along a similar path. It might be a one-sided convergence, where one person changes their routine to match the other person's, or it might be dual-sided. The amount of alteration to match another person or group's aggregate behaviors also provides some indication of influence.

Influence works as a modifier wildcard in groups. If there's no clear consensus, the person within the group who has the highest influence score on the group will have their choice prioritized. Influence essentially serves as a +1 to the affinity score (e.g. max score) but is only triggered if there is not a clear “winner” in a decision context. In most contexts, influence is as simple as looking at the aggregate of each user's 1:1 affinity score with every other person within the group. The person who has the highest aggregate 1:1 affinity score will have the influence trump point. In some contexts, influence might be more dynamic when enough information has been fed into the social context engine. For example, historical data within a context of ordering food may show that the group typically defers to a particular user's preferences, and if that occurs, that particular user is given the influence point in the event of no clear group consensus.

Availability is whether or not a person is free to engage in a conversation or social interaction.

Activity of the person is looked at first—the system determines if a user is with people who have a high affinity score with the user already. If so, then they are marked as unavailable for the purposes of the particular interaction at issue.

If enabled by the user, activity with people that have high social affinity scores, then accessing a device, will prompt the user with topics to bring up with the group and apps that help with social planning. Activities also include any known context (at home, at work, meeting on the calendar). These activities may trigger different content to be available to the user.

For example, the core service may detect that User A has a meeting with his boss User C to review the strategy of project X. From the logs of recent activity, the service knows that User A has been working on a PowerPoint of Project X and when User A accesses one of his devices, Project X is made available for his use.

As one example of modification of availability, if a user is wearing headphones, they will be prompted to mark themselves as available or unavailable although they will always be marked unavailable if the volume goes above 80% on their headphones, or if they are using the microphone, whether in a call or for another purpose

In the case of an app that encourages people to have conversations, in some embodiments, systems of the present invention use information such as: the state of headphones (wired and wireless), whether or not a person is on a call (regardless of headphones being connected), whether or not music/movie audio is playing from the speaker (which can suggest they are sharing the experience), if they are still or in a vehicle (and not walking, biking, or running), and whether or not their screen is on. Notifications of a potential match may only be provided if all of those conditions are met. A match may be a recommendation, and in this case it takes the form of a recommendation suggesting a possible conversation to each person.

The type of app the user is currently running will also be evaluated with time-wasting apps or apps that have been classified (either manually or via machine learning techniques) as ones users turn to during awkward social interactions as triggers for the social context engine.

In one embodiment of this invention, the social context engine can be used to help trigger another app on the device that is connected to the service of the present invention.

Here is an example of use of the present invention during a date:
A) User A is on a first date with User Z after meeting on a dating app.
B) Ten minutes into the date, User A pulls out her phone and the dating app, using the social context engine to identify the presence of user Z, provides a story they both read online that day to keep the conversation flowing.
C) User A repeats this behavior two more times within a three-minute period and that triggers a prompt if User A would like an exit strategy, which User A accepts.
D) The dating app to launch the call app to provide a fake incoming call from User A's mom.
E) User A is then able to “take” the call and exit the encounter with User Z.

Other availability inputs may include but are not limited to:
Current Time
Calendar Status
Messaging application Status/Presence Information
Battery Status
Call Status
Connectivity Status, etc.

The following summarizes various social factors as used by embodiments of the present invention, along with sub-factors within each factor and practical and numerical examples of the use of these factors within the present invention:

[symbol]

### I. Factor: Proximity

A. Sub-Factor: Physical Proximity
How to Measure: Location reporting from multiple Devices. This includes Latitude, Longitude in degrees as reported by user's devices, Altitude above sea level, Delta Distance between two users. User's Mobility status.
Examples: John and Appleseed are registered users of an app using this invention. The service knows the respective users through the latitude and longitude reported by the users' devices. This in turn is used to compute the delta distance between the two users or nearby users.
Emily and Sam are indoors in a convention center, WiFi or Beacon based systems using Signal Strength or Round Trip Time mechanisms to compute distance are used to calculate the delta distance between two users.
Mobility status can be derived from location update frequency or on device sensors such as accelerometers.
Numeric Example: Physical proximity may use GPS coordinates, with the difference in distance being a simple decimal.
In cases of users being nearby, proximity may be measured by signal strength of bluetooth, Wifi, RFID, or the relative volume of ultrasonic sound. This would also be a decimal based number.
B. Sub-Factor: Physical Sameness
How to Measure: User-reported or inferred via image or audio recognition
Examples: John reports gender on the application as part of a profile. This information is used while making recommendations.
Emily doesn't include gender in her profile but uploads a profile picture; gender can be inferred via image recognition.
Numeric Example: This could be on a scale from 0 (not at all the same) to 100 although it may also be done with other degrees of difference (e.g. fewer or more numbers or 0-1 with decimals).
C. Sub-Factor: Digital Locations
How to Measure: Digital breadcrumbs (browser history, app logs, etc.)
Examples: John has installed an app that uses this invention. The application seeks user permission to track usage pattern on his smartphone. Percentage Time spent per day/Usage variance based on time of day is used to provide contextual suggestions.
Numeric Example: Timestamped (month, day, year, hour, minute, second, and potentially milliseconds) log of location coordinates (such as GPS).

[symbol] [0099] C. Sub-Factor: Temporal Overlap
How to Measure: Location history (timestamped)
Examples: John visits Starbucks Coffee shop on weekends at around 5 pm. Emily visits a nearby bookstore at around the same time on weekends. Application can provide nearby suggestions based on the timestamped location information.
Numeric Example: Entry and exit time for a given GPS location (or boundary area) and difference in time and location of the other individual. At a basic level, this is an integer of the total amount of time spent in the same location. In some instances, this may be a simple Boolean variable.

### II. Factor: Sentiment

A. Sub-Factor: Shared Hobby Interests
How to Measure: User Reported/Activity History/Location History
Examples: As part of an application profile, John lists hobbies and interests that he is interested in. This information is used to calculate affinity.
Emily uses the NYTimes App on her phone to read news every day, the usage pattern is used to predict hobbies and interests. Todd is an avid runner and uses his smartphone while running, the activity and location history information is used to determine this interest.
Numeric Examples: Users will be able to select from pre-defined interests or hobbies as well as fill in their own. If enough users enter in an interest or hobby, then it becomes a choice for other users. This then starts at the highest score but may be reduced if it is learned that the user's behaviors don't align with this self-classification (e.g. it was only aspirational) such as indicating an interest in baseball but never going to baseball fields, never searching for baseball related items, etc.
Third party services or the classification of the system of the invention will identify locations as being associated with interests (e.g. a baseball stadium with baseball). The more frequently these locations are visited and the longer the user stays in these areas, the more the score increases. Activities are measured by mention of hobbies or interest in searches, emails, or other communication the user has granted the service access too. The more frequently the topic is mentioned then the higher the score.
As hobbies/interests may change over time, the service may also have a gradual decay of the score if a topic is not brought up for a long period of time. This decay rate will vary by topic as some items (such as ice skating) may be seasonal so they will not decay during the off season when no (or very few) users are mentioning those topics.

[symbol] [0111] B. Sub-Factor: Shared Affiliation with Group
How to Measure: User Reported/Implied through their digital & physical locations to different categorized interests
Examples: Emily and John are both volunteers with Boys & Girls Club of America. While the two have never met, when they are both attending a conference on zoology, the conference app suggests the two of them have a conversation with one another (ranking each other higher than other potential recommendations) because both have a high affinity score with the Boys & Girls Club of America and attend fund raising events with them frequently.
Numeric Examples: This scoring works the same as hobbies/interests, but focuses on a more granular level (such as a specific baseball team rather than baseball).
In addition, Shared Affiliation looks for individuals that have high affinity to others who frequently spend time in close proximity. This looks at the frequency of time that individuals spend together and the length of time they together, and approximates relationship based on time of day (e.g. coworkers if the overlap is primarily 9-5 on weekdays). This overlap may also be digital (using the same services/sites).
Scores have a decay factor if there is prolonged time apart. These scores range from 0 (non-existent) to 1 (full connection). It is to be understood that ranges such as this may be scaled up or down on any arbitrary scale as befits any particular application of an algorithm. For example, in some embodiments, a score such as this could range from 0 to 100.
C. Sub-Factor: Strength of Involvements
How to Measure: User Reported/Measure frequency and duration of activity over a period of time. Measurement be direct (for example fitness tracking app, browser activity, such as visiting political sites, etc.) or indirect (user goes to theater or restaurant often).
Examples: John uses his tablet/smartphone to read novels on an e-book app for 2 hours every day. This information can be used to infer that John is an avid reader.
Emily bikes for 1 hour on weekdays and for extended durations on weekends. This information can be used to infer that Emily is an avid cyclist who is committed to the hobby.
Numeric Examples: Strength of involvement is a secondary factor and is part of the calculations described above using the recency and frequency. Just the presence or absence of those traits are the simple measure for interests/hobbies and group affiliations.

### III. Factor: Action

A. Sub-Factor: Ratings of Interactions
How to Measure: User/community reported/Measure time spent with others
Examples: Emily decides to go to a youth group and after the meeting the app that suggested it asks her to rate her experience. She gives it a score of 1 (lowest score) and indicates she felt patronized there. The next time she uses the app to find activities, groups consisting of individuals who have similar behaviors and interests as the youth group are moved to the bottom.
Numeric Examples: For self-rating, users may directly rate the interaction on a scale (e.g. 1-5) or through a rating of how they feel after on various dimensions (e.g. intellectually stimulated; happy; listened to, etc.). These will then be averaged to create a median score of positive interaction. These scores may be 1:1 or may apply to others depending on context. For example, 1:1 ratings may be used when individuals are seeking recommendations involving activities with other individuals, while 1: many ratings are used when an individual is looking for a recommendation for an activity with a group.
This is intended to recognize that different people have different tolerance levels for various behaviors or beliefs. If a person's time spent with another person (as measured by frequency and time spent within 100 m) increases, the rating of previous interactions goes up (positive) while decreased time leads to a declining score. The total score ends up on a scale from 0 to 1.
B. Sub-Factor: Changes in Behavior/Routines
How to Measure: Comparing average breadcrumb (physical & digital) path to new path vs. another person or group's aggregate (e.g. convergence)
Examples: Emily routinely visits a JustJava coffee shop everyday. John recommends a new coffee shop to Emily via the app, Emily starts visiting the new coffee shop more often. The trend is analyzed and is registered as a change in user behavior.
Numeric Examples: This looks at the delta (change) in location and time in various places. This could be a one-sided change (only one user changes to adjust to the other user) or a mutual change (both users adjust their schedule or locations to spend more time in proximity). This delta is a difference in time spent as well as difference in distance over the course of the day
C. Sub-Factor: Decisions made on recommendations
How to Measure: User acting or not acting on a recommendation and any reason for the rejection of the recommendation
Examples: Emily is with John and searches for a coffee shop. The recommendation comes up for JustJava as a best match for coffee preferences for both her and John. However, Emily selects Kona Koffee (the 5th result) instead a place that more closely matches John preferences than her own. The system records a possible influence John has over Emily's preferences when they are together and the subsequent primary recommendation.
Numeric Examples: When a recommendation is delivered via an experience, the user's decision to act on it or not is recorded. As they act on recommendations that favor the preferences of another person vs. their own individual historic choices than the affinity score increases between the individuals (approaches 1). Similarly, a recommendation based on users affinities to a hobby, brand, etc. accepting recommendations that align with those increase the score.

### IV. Factor: Awareness

A. Sub-Factor: Interactions with a person
How to Measure: Chat & call logs/Frequency & length of time within 25 meters. Following each other on social media; reading posts.
Examples: John and Emily got introduced via an app using this invention. With the appropriate user permissions, the app on the device tracks call logs to determine frequency and duration of interactions between John and Emily. Accordingly, the awareness score is adjusted.
Numeric Examples: Count of frequency and amount of time spent in conversation on phone or messaging experiences where the user has granted the service permission to do so. The count of times within 25 meters and length of time of those interactions are also tracked.
B. Sub-Factor: Knowledge of shared interests
How to Measure: Users mentioning common interests in conversations together or physical presence with one another during these interests.
Examples: John and Ryan share an interest in ice hockey. An app using the invention detects both John and Ryan at Ice Hockey venues multiple times. Accordingly, the app infers a shared interest in ice hockey for both John and Ryan. This information will be used in calculating social affinity to provide future suggestions.
Numeric Examples: These are binary items (true or false) for whether or not interests, groups, or hobbies identified by the system are present for both individuals and whether or not the two individuals have been within close proximity at the same time as their involvement with those activities or have mentioned it through communication channels the user has given the system permission to access for scoring purposes.
C. Sub-Factor: Knowledge about infrequently shared information
How to Measure: In advanced iterations where users have provided explicit permission and identified certain pieces of information as key to their social relationships, systems according to the present invention will use sharing of semi-private information by the user to another user in order to track sharing of infrequently shared information as a sign of close, personal relationships. Infrequently shared information includes information that is related to items the user has explicitly labeled private, that come up rarely in e-mail or chats, or that are among topics known to be considered secretive within a culture (e.g. pay within American culture; sex life in Middle Eastern culture). This can also be measure via users mentioning or physical presence with one another during these interests.
Examples: John shares information about his medical condition and marks it as private information. He shares this information with Cathy. Similarly Cathy shares information about her work situation with John and marks it as private information. The application keeps track of the frequency with which private information is shared with another user or a select group. The application uses this score to infer closeness of user to another user or to a group.
Numeric Examples: This is a binary (true or false) based on whether or not a user has marked something as personal information and then shares it with another individual in some way.

Specific use cases based on integration of the platform of the present invention into different experience contexts (e.g. apps) will now be provided.

Data can be used to infer a ‘social context’ that nearby users may find themselves in. This may include identifying if the user is currently available or open to communication (whether or not they are currently on a phone call, whether or not their headphones are connected to their phone, are there other people near them that are known intimate connections, what's the current volume on their device, etc.). If the platform determines that a user is not engaged in a phone conversation and they are just killing time (e.g. we find out they have a game app open) but are near others who (like them) also have a networking app installed then both users will be notified of a potential connection. In other words, the user is identified as being available.

An example of this is the use of the platform of the present invention for an app aimed at connecting people. For example, three users in a subway car may have an app designed to get people to begin new conversations installed on their devices. In instances where all interactions occur within a 100-meter proximity, information may be transferred directly between devices. In those instances, images and other files may be converted to Byte 64 files to enable direct transference. In this particular instance, that is how data is transmitted.

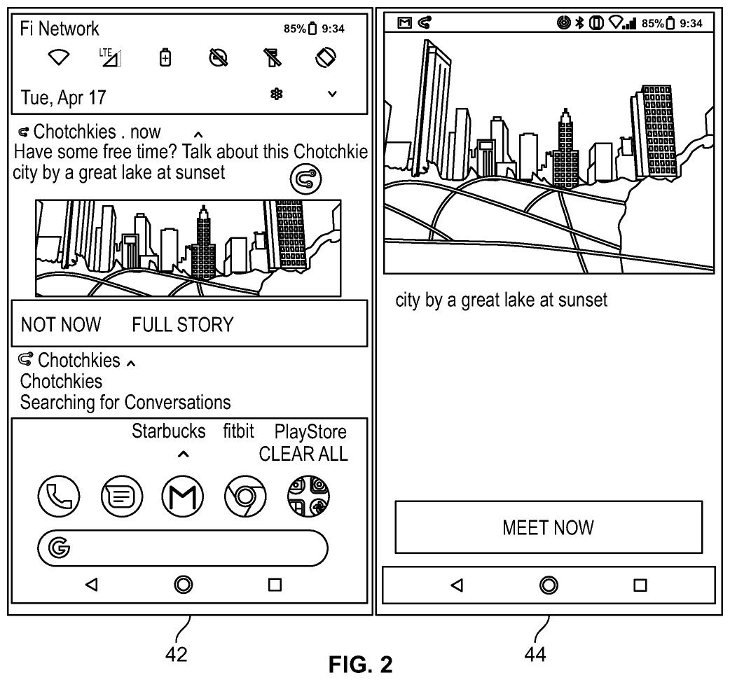

In one example, User A begins listening to music providing a cue that they are not open to conversation and are excluded from possible matches. Conversely, User B begins playing a game while User C begins looking at photos from a social network application. In this app context, the app or another background service pushes notifications to nearby devices informing users B and C of a match. Screen shots illustrating such a process are shown in FIG. 2, in which screen shot 42 shows a platform according to the present invention providing the user with the option to have a conversation about a specific topic, and screen shot 44 provides the user with the option to meet another user.

Affinity matching may identify that users B & C typically take this same route every morning within 5-10 minutes of one another although they pick the subway up and exit at different points. In this example, proximity matching reveals that they have 80% overlap on their apps and site visits. Combining with physical proximity, their match on this area is 60%. As both users are shown to be currently in a subway, an inaudible tone is played on one device while the microphone on the other device listens for it. When the other device picks it up, both devices are confirmed to be within the same subway car. Their awareness is found to be 0%, which provides a matching potential score of 100% within the social connections app (as its intended usage is for matching strangers). Political affiliations are polar opposite, but both Use B & User C spend a considerable amount of time researching political issues including on similar political sites (providing a sentiment match along this spectrum of 50%). In addition, both are huge fans of the local baseball team attending five games per year apiece and spending 3 hours each week during baseball season on the same fantasy baseball site and statistics pages (moving their sentiment score up to 70% overall). The total affinity score within a social matching experience context might be proximity (60%)+Awareness (30%)+Sentiment (10%) with activity being excluded as the users have no prior interactions. Making the affinity score in this case 0.8(0.6)+1(0.3)+0.5(0.1)=83%. User B & User C receive a match recommendation, and both choose to pause their game and have a conversation. Their acceptance of the match and action on the conversations is brought into the action part of the affinity calculation and their match is stored and tracked in the database.

Over the coming weeks, User B & User C begin altering their commute to always take the same subway and sitting in the same car, this then leads to a total affinity score over 80% and the app for new social connections removes the two as a possible match. This 80% match is later used when they are with User A & User G planning on a lunch location. Since User B & C have high affinity while neither A nor G have affinity scores about 30% with B or C, the lunch ordering app assumes that only B & C are placing a lunch order together. This then saves user B time as it automatically pulls in user C's eating preferences and makes a match that they are both agreeable to.

In another scenario, User B & User A have both provided information to the service that they have marked for selective disclosure. In the case of User A, this is information about her family history and that she visits her family every week. Family is important to User A, but she doesn't want to make others aware of it until she has reached a certain level of comfort. User B chooses to keep his past time serving as a senate page in high school secret. While he is proud of this part of his history, he knows political affiliations may turn people away. After User A & B both show affinity growing at a rapid rate, the Conversational App places questions into each user's queue that allows each of them to disclose this information voluntarily or keep it hidden.

In the case of User A's information about the family, User B is prompted to ask User A about her relationship with her family. User B's information is suggested to User A by suggesting she ask User B for a favorite memory from a job in high school. The conversation app then closes the information loop by either listening for the question and if it (or a variant) is asked then it listens for the answer and reports back to the service that information has been shared. Alternatively, the user who has the private information might be prompted later in the evening or the next day to determine if their own private information was shared.

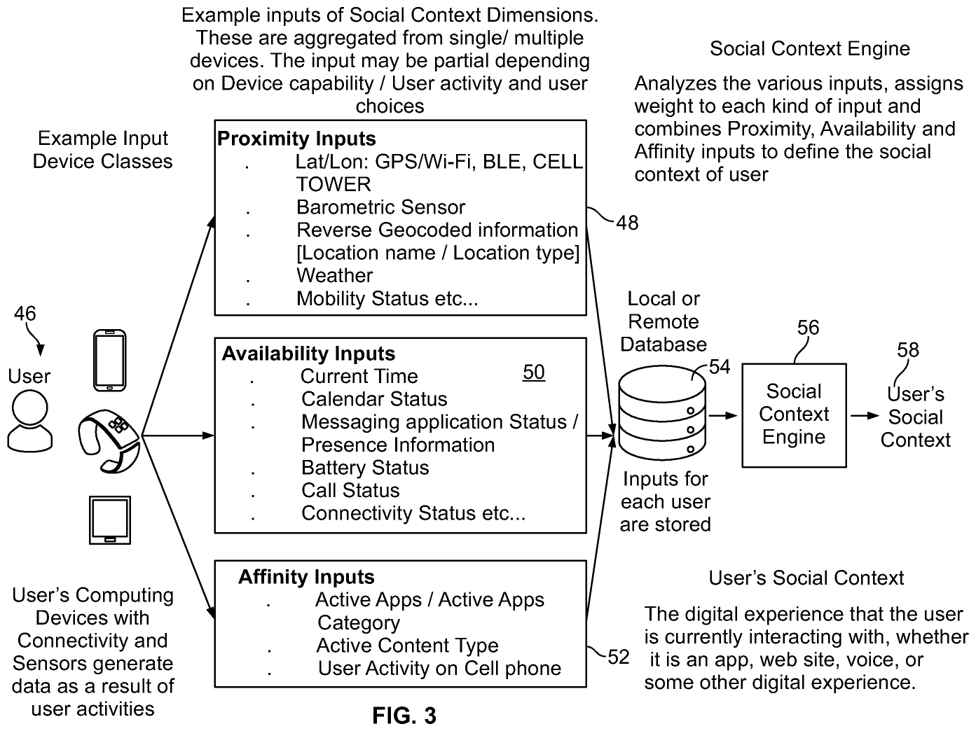

FIG. 3 shows how proximity, availability, and affinity inputs can be combined for use in a social context engine according to one embodiment of the present invention. Sensors associated with a user, as shown at 46, generate data which are classified into proximity inputs 48, availability inputs 50, and affinity inputs 52. These inputs are stored in a local or remote database 54, and then evaluated by a social context engine 56, to generate a user's social context 58.

In another embodiment, systems of the present invention may incorporate the information that a user has a food ordering app open and there are three people within close proximity that we know the user has dined with in the past.

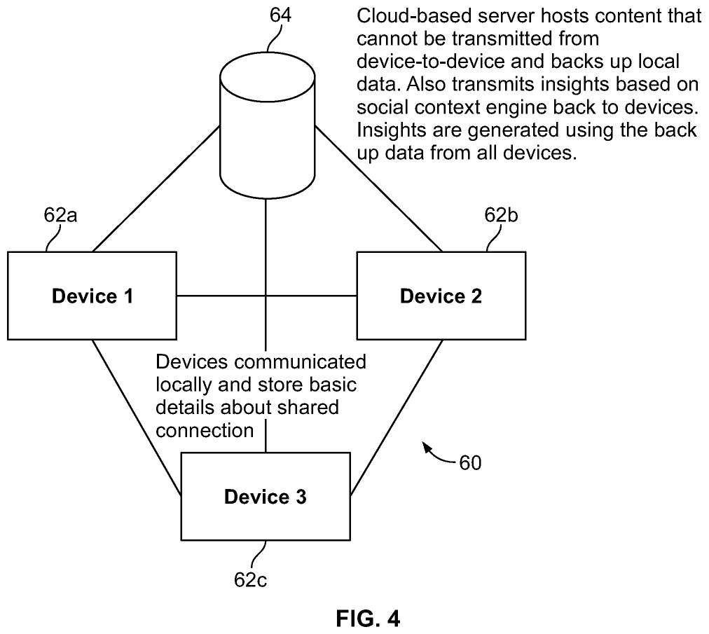

FIG. 4 illustrates a hybrid architecture 60. In one embodiment, availability and proximity (non-historical) are communicated locally in a device-to-device network (FIG. 4 shows three devices operating this way: devices 62a, 62b, and 62c. A server 64 handles processing of historical data and storage of assets (such as images) that are less efficient to transfer locally.

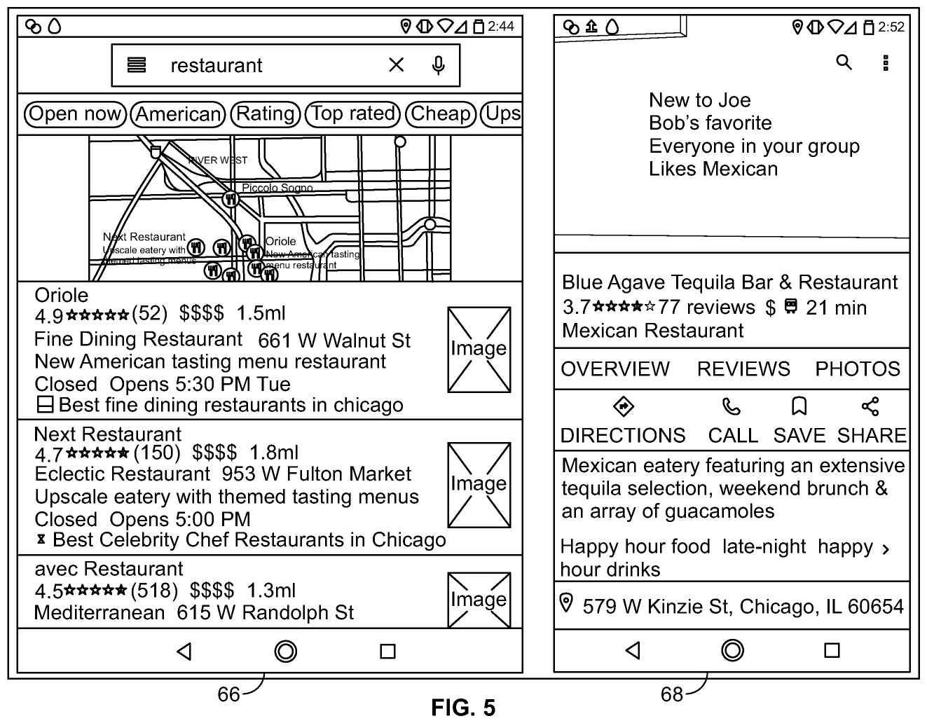

FIG. 5 illustrates a use of an embodiment of the present invention in searching for a restaurant. A first screenshot 66 shows an example of a restaurant suggestion screen in which a user is presented with three suggestions. Three restaurants are suggested with indications of which one best matches the preferences or past eating history of nearby users, as well as a label such as “favorite of one user” or new to everyone. Options may be presented allowing users to choose the option that is most likely to please everyone, something new and highly rated, something that fits all budgets, or something that fits all typical food preference. Proximity ratings may be modified according to weather or user restrictions on distanced of a search, and who is near the user. The affinity score may be modified regarding whose opinions matter the most as part of a ranking. A second screen shot 68 shows a recommendation provided by a system according to the present invention, taking into account factors known by the system about the users who wish to meet.

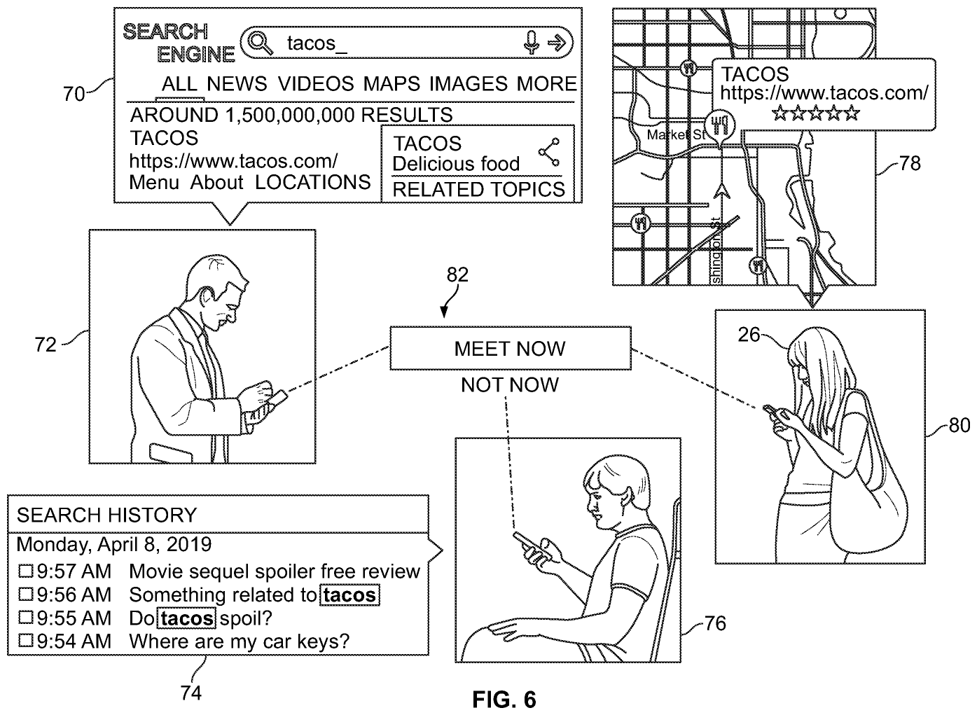

In another example, a map or food ordering service empowered by the present invention informs the service that a user is looking to order food. The service looks for other users within close proximity to the user and evaluates the affinity rating of each individual. This embodiment is illustrated in FIG. 6. In this illustration, a first selection of information 70 associated with a first user 72, a second selection of information 74 associated with a second user 76, and a third selection of information 78 associated with a third user 80 are aggregated by a social awareness system according to the present invention to prevent each user with a choice 82 as to whether the users wish to meet other users now for, in this case, tacos at a recommended location.

In this case, proximity for affinity is kept to a 10% weight in the affinity score although it does go through a filter to ensure users are within 100 feet of one another. Influence becomes a factor in the decision-making process for food if there is a need for a tie-breaker around preferences for different food choices. This situation might occur where we have User A whose order history (from restaurant visits and orders across multiple apps) shows food preferences ranked as Indian, Ethiopian, and pizza along with a high-sentiment in favor of exploring new foods. In this example, User A has an affinity ranking with the group of 82% and with User C (who opened the app) of 25% (User A has the highest affinity score with User D, who traveled with User A from their shared place of work). User B has food preferences that rank pizza, Mexican, and Chinese in that order. User B's affinity with the group is 68% with the highest affinity with User D. User B is also a strict vegetarian. Further, in this example, User C is the one who opened the app and has the lowest sentiment for exploring new foods. User C's food preferences are ranked burgers, Italian food, and Indian. User C's affinity with the group is 40% (having just met users A & B) with User D being the highest affinity (80%). User D has the highest affinity score with the group and has several times in the past modified the standard behaviors of Users A, B, and C garnering her the influence trump. User D's food preferences are Thai, Italian, and Chinese. Indian and pizza tie in the possible food match and both adhere to User B's need for vegetarian food. Vegetarian food in this case is a constraint, although it is handled by the system in the same manner as a preference although in this case the preference would have the highest weight within the affinity score (a perfect score of 1 for items not containing meat and a score of 0 for those containing meat). Pizza ranks higher in user D's food preferences as she has not ordered Indian food in the past 5 years.

The primary recommendation presented to user C is pizza. Since user B has the preference of 0 for meat-based dishes, a vegetarian pizza is recommended for the group. After the user selects an order, this information then feeds back into subsequent recommendations.

If a choice was made that clearly favors the preferences (or avoids the preferences) of a member of the group, then that is also stored as information to consider for future recommendations. The service will also provide an interface for merchants and marketers. A 1: many affinity score, which looks at the affinity strength between an individual and a class of other entities, may be provided to marketers so that a ranked list of users with high affinity to the brand, product, or service will be provided (e.g. scores 0.7 when 1 is the maximum). Individuals' affinities with their groups will also be provided as well as a count of instances where the individual has influenced a decision. When an ad campaign is created, the marketing user will be able to track the affinity score with the brand (e.g. locate all people above a threshold of affinity on a 0 to 1 scale), product or service of others in the group that the influencer they have selected to target. Positive changes in affinity will indicate successful improvements in the campaign and provide compensation to the influencer from the marketer. The platform may take a percentage or a flat rate for these transactions.

In an example, a user with a high brand affinity (0.83) has a high influence score among a group with low brand affinity (all of them are between 0.2-0.4). After the brand campaign kicks off, the user starts introducing other members of the group to the brand and their affinity with it jumps up to 0.54-0.63. This increase in affinity of the group would then kick off the incentive payment to the individual.

In one embodiment of the invention, marketers will be able to see what type of affinities an aggregate view of individuals have with their product or service, as well as the relative strength of affinity of specific products or services with other portions of that group. Marketers will be provided with a means to incentivize individuals (they may not have direct contact or know the identity of these individuals) who already have strong product affinity for any influence they choose to provide over the other members of their social group to use a product or service. This influence may be tracked based on the affinity to the product or service of the other individuals and their interactions with the targeted influencer.

Targeting may also be possible based on relative strength to the category of offering, such as fast food, where marketers can target individuals who have a high affinity from past behavioral patterns (visiting fast food locations, searching for it, discussing it, etc.) as well as segmentation by loyalty to a particular offering (those who do not have a clear affinity for one chain over another vs. those who have affinity for McDonalds).

One embodiment of this invention may use affinity to areas of expertise and other people in a person's network to provide an affinity score to serve as a proxy for trust. For example, if a person is planning to book a babysitter the service might be pinged to find someone who already has some level of contact with the requestor (weighting proximity and including contact with high affinity people as part of the digital affinity). A possible weighting of this would be 50% for the skill, 35% for proximity (closer to the location of the user, the higher the score), and 15% for affiliation with someone who has a high affinity.

After finding the individuals with the highest affinity score, the service then sorts them by the people with the highest affinity to the expertise requested (babysitting) with an extra weight where that service has been provided for an individual in the user's network. This affinity score may also be used for things like hailing a ride service or hiring someone to do a gig. In an enterprise setting, this would not use those with the highest affinity to the individual but would instead use the highest affinity score to the necessary skill and any relevant work culture values. This change in weighting is intended to reduce biases built into traditional social networks of people who are like oneself.

In another example, a user may open the maps app. The map provides a list of locations with people that have a high potential affinity rating (estimated from shared or third-degree connections) and are open to conversation (not in a small or large group of high affinity people). This is intended to give people a way to meet and mingle with people as a means of spending their time when their friends are busy or they just want to meet some new people.

‘Affinity measures’ such as users being frequently embedded in the separate but similar social contexts present an opportunity to suggest connection. This might include physical footprints (such as always going to a coffee shop between 8-8:30 AM—this might not be the same coffee shop, but they may always cross paths daily between 8:30-8:45) or digital (NYTimes.com, Financial Times, etc. are all opened and read around similar times or during similar portions of their day—e.g. during the morning commute). This could also be more nuanced on the topic level of both users read articles (regardless of which site) on the latest Brexit update. In the case of both users reading an article on the same topic, a networking app or one that tries to enrich conversations with people might suggest that piece of news as a topic for discussion.

The database will identify other users and devices in that location that have at least one application service, or piece of hardware with the social awareness service installed).

Embodiments of the present invention may also carry out the following tasks:
Based on the location and the other people nearby running an app that contains the service, different options will be available to the user;
The database may also check to see frequency of proximity to the other person and any past interactions that have been shared across devices, applications, and locations;
Utilize the connected devices in an area to get a sense of what people interact with, have connections with, and can map;
Digital footprint of what sites, documents, etc. people visit and when (virtual location). This would be useful in suggesting digital connections;
“External data” such as social media activity may be collected to enhance inference of social context;

### Alternative Embodiments or Ways of Using the Invention

In one embodiment of this invention, the preferences and priorities of the group are considered instead of a solo requestor;

This may be a background service that takes in input from hardware and software a user has installed in order to understand the context of interactions;

The service may be able to run within existing applications or in embedded Internet technologies, such as Amazon Echo & Google Home speakers; and/or

Devices and applications with the service installed may report their location and activity (microphone in use, camera in use, applications running, etc.).

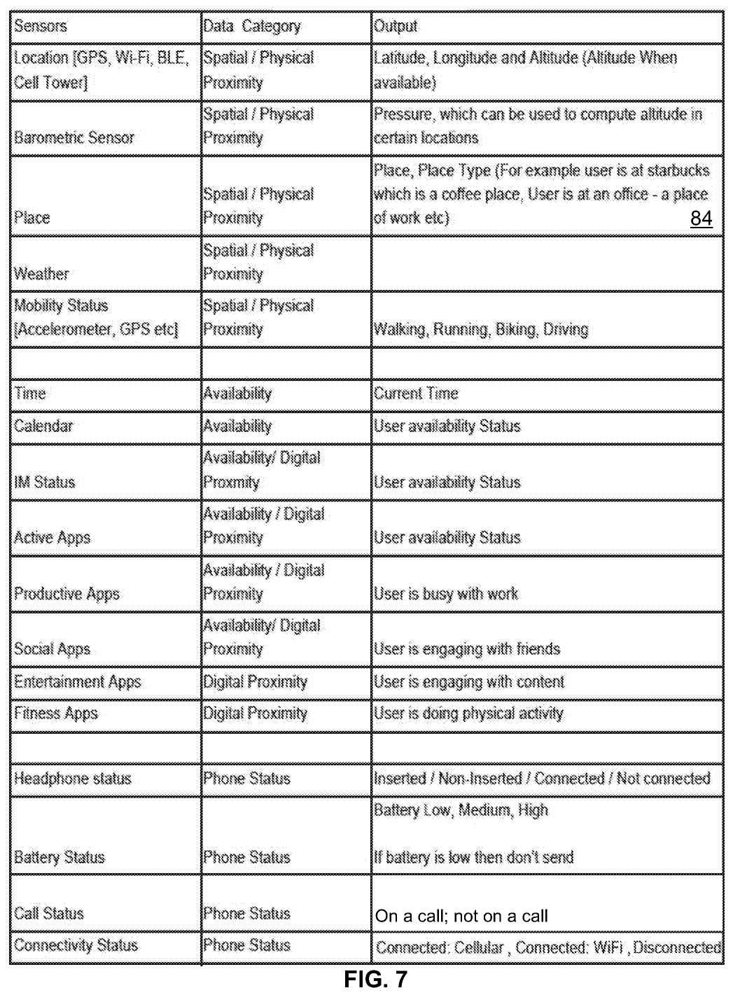

Systems and methods according to the present invention may use a variety of sensors to generate categories of data about users, and these categories of data about users may be aggregated into outputs as shown in chart 84 in FIG. 7.

The methods and systems discussed herein may be implemented via one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of the methods in response to instructions stored electronically on an electronic storage medium. The one or more processing devices may include one or more devices configured through hardware, firmware, and/or software to be specifically designed for execution of one or more of the operations of the methods.

The server(s), client computing platform(s), and any other discussed third parties may be communicatively linked via one or more electronic communication links. For example, such electronic communication links may be established, at least in part, via a network such as the Internet and/or other networks. It will be appreciated that this is not intended to be limiting, and that the scope of this disclosure includes implementations in which server(s), client computing platform(s), and any other discussed third parties may be operatively linked via some other communication media.

A given client computing platform may include one or more processors configured to execute computer program modules. The computer program modules may be configured to enable a user associated with the given client computing platform to interface with the described systems and methods and/or provide other functionality attributed herein to client computing platform(s). By way of non-limiting example, the given client computing platform may include one or more of a desktop computer, a laptop computer, a handheld computer, a tablet computing platform, a Smartphone, a gaming console, a VR/AR headset or other device, and/or other computing platforms.

Server(s) may include electronic storage and one or more processors, and/or other components. Server(s) may include communication lines, or ports to enable the exchange of information with a Network and/or other computing platforms. Illustration of server(s) is not intended to be limiting. Server(s) may include a plurality of hardware, software, and/or firmware components operating together to provide the functionality attributed herein to server(s). For example, server(s) may be implemented by a cloud of computing platforms operating together as server(s).

The electronic storage may comprise non-transitory storage media that electronically stores information. The electronic storage media may include one or both of system storage that is provided integrally (i.e., substantially non-removable) with server(s) and/or removable storage that is removably connectable to server(s) via, for example, a port (e.g., a USB port, a firewire port, etc.) or a drive (e.g., a disk drive, etc.). The electronic storage may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storage may include one or more virtual storage resources (e.g., cloud storage, a virtual private Network, and/or other virtual storage resources). The electronic storage may store software algorithms, information determined by processor(s), information received from server(s), information received from client computing platform(s), databases and/or other information that enables server(s) to function as described herein.

Processor(s) may be configured to provide information processing capabilities in server(s). As such, processor(s) may include one or more of a digital processor, an analog processor, a digital circuit designed to process information, an analog circuit designed to process information, a state machine, and/or other mechanisms for electronically processing information. Although processor(s) may function as a single entity, in other implementations, processor(s) may include a plurality of processing units. These processing units may be physically located within the same device, or processor(s) may represent processing functionality of a plurality of devices operating in coordination. Processor(s) may be configured to execute instructions for applications, or modules, by software; hardware; firmware; some combination of software, hardware, and/or firmware; and/or other mechanisms for configuring processing capabilities on processor(s). As used herein, the term “module” may refer to any component or set of components that perform the functionality attributed to the module. This may include one or more physical processors during execution of processor readable instructions, the processor readable instructions, circuitry, hardware, storage media, or any other components.

The various messaging and data transfer described above can be accomplished with a REST API (or “RESTful” API). A RESTful API is an application program interface (API) that uses HTTP calls to request resources as opposed to functions. The function is embedded in the HTTP call through requests to GET, PUT, POST and DELETE, for example. The API spells out the proper way to request data, from an operating system or other application and allows management of customer data, sales orders, inventory, and products. This entire process can be open-sourced to the general public through permissioned API endpoints and PGP keys for encryption of data transmission in a single package as an SDK.

The description contains depictions of embodiments of the invention, which are not meant to limit the scope of the invention. The scope of the invention is as defined in the following claims.

1. A system for generating a recommendation for a user, comprising: a data processor collecting raw user data about the user; and
a learning engine analyzing the raw user data to generate weighted social aspect scores and further to generate a social affinity score using said weighted social aspect scores, said learning engine combining said social affinity score with information about people near the user to generate a social context, said learning engine further evaluating an availability of the user to determine whether or not to provide said recommendation based on said social context to said user.

2. The system of claim 1 wherein said information about other people comprises social affinity scores of said other people.

3. The system of claim 1 wherein said recommendations comprise recommendations about meeting with or conversing with said people near said user.

4. The system of claim 2 wherein said learning engine further evaluates an availability of said people near said user to determine whether or not to provide said recommendation to said people near said user.

5. The system of claim 1 wherein said weighted social aspect scores comprise a weighted proximity score, a weighted sentiment score, a weighted action score, and a weighted awareness score.

6. The system of claim 5 wherein said weighted proximity score comprises a numerical score based in part on physical locations of the user and said people near the user.

7. The system of claim 5 wherein said weighted sentiment score comprises a numerical score based in part on shared hobby interests between said user and said people near the user.

8. The system of claim 5 wherein said weighted action score comprises a numerical score based in part on changes in behavior or routines of said user in relation to previous interactions with specific ones of said people near the user.

9. The system of claim 5 wherein said weighted awareness score comprises a numerical score based in part on a number of interactions between said user and specific ones of said other people near the user.

10. A method for generating recommendations for a user comprising: gathering raw user data;
sorting said raw user data into sorted user data in user data categories;
providing said sorted user data in user data categories to a learning engine;
using said learning engine to modify said sorted user data using weights for each type of information to create weighted social aspect scores;
combining said weighted social aspect scores to create a social affinity score;
combining said social affinity score with an evaluation of people near the user to determine a social context for generating a recommendation;
determining user availability; and
providing a recommendation to the user if said step of determining user availability shows that the user is available to receive the recommendation.

11. The method of claim 10 further comprising evaluating user actions following a recommendation and aggregating such user actions into a user action history.

12. The method of claim 11 further comprising incorporating said user action history into the generation of recommendations.

13. The method of claim 10 wherein said user data categories comprise the categories of proximity, sentiment, action, and awareness.

14. The method of claim 10 wherein said weighted social aspect scores comprise weighted versions of a proximity score, a sentiment score, an action score, and an awareness score.

15. The method of claim 14 wherein said proximity score comprises a numerical score based in part on physical locations of the user and the people near the user.

16. The method of claim 14 wherein said sentiment score comprises a numerical score based in part on shared hobby interests between said user and said people near the user.

17. The method of claim 14 wherein said action score comprises a numerical score based in part on changes in behavior or routines of said user in relation to previous interactions with specific ones of said people near the user.

18. The method of claim 14 wherein said weighted awareness score comprises a numerical score based in part on a number of interactions between said user and specific ones of said other people near the user.

19. The method of claim 10 wherein said weights are changed dynamically over time based on a context in which said recommendations are to be generated.

20. A method for generating recommendations for a user comprising: gathering raw user data;
sorting said raw user data into sorted user data into user data categories, said user data categories comprising data about proximity, sentiment, action, and awareness;
providing said sorted user data in said user data categories to a learning engine;
using said learning engine to modify said sorted user data using weights for each type of information to create weighted social aspect scores comprising a weighted proximity score, a weighted sentiment score, a weighted action score, and a weighted awareness score;
combining said weighted social aspect scores to create a social affinity score;
combining said social affinity score with an evaluation of people near the user, along with evaluations of social affinity scores for said people near the user, to determine a social context for generating a recommendation;
determining user availability; and
providing a recommendation to the user if said step of determining user availability shows that the user is available to receive the recommendation.
